(19) United States
(12) Patent Application Publication
(10) Pub. No.: US 2007/0157457 A1
(43) Pub. Date: Jul. 12, 2007

(54) Assembly Method and Machinery for Waterproof Testing of Electronic Devices

(76) Inventor: Lance Fried, San Diego, CA (US)

Correspondence Address: STETINA BRUNDA GARRED & BRUCKER, 75 ENTERPRISE, SUITE 250, ALISO VIEJO, CA, 92656, US

(21) Appl. No.: 11/567,713

(22) Filed: Dec. 6, 2006

Related U.S. Application Data
(63) Continuation-in-part of application No. 11/222,163, filed on Sep. 8, 2005.
(60) Provisional application No. 60/608,856, filed on Sep. 10, 2004.

(51) Int. Cl. H01S 4/00; G01M 3/26

(52) U.S. Cl. 29/592.1; 73/40; 381/58; 84/453

(57) ABSTRACT

A method of waterproof testing an electronic device at a rated water depth is provided. The method may comprise the steps of assembling the electronic device; subjecting the electronic device to a test vacuum pressure associated with the rated water depth; measuring a leak rate of the electronic device after the electronic device is subjected to the test vacuum pressure; rejecting the electronic device if the leak rate is above an allowable leak rate; and accepting the electronic device if the leak rate is below the allowable leak rate.

### CROSS-REFERENCE TO RELATED APPLICATIONS

This application is a continuation-in-part of application Ser. No. 11/222,163, filed Sep. 8, 2005, the entire contents of which is expressly incorporated herein, which claims the benefits of U.S. Provisional Application No. 60/608,856, filed Sep. 10, 2004, the entire contents of which are incorporated herein by reference.

### STATEMENT RE: FEDERALLY SPONSORED RESEARCH/DEVELOPMENT

Not Applicable

### BACKGROUND

The present invention relates to a process for assembling and/or testing a waterproof and/or shock resistant electronic device and also to machinery for assembling and/or testing the waterproof and/or shock resistant electronic device.

Active people, hikers, surfers, snowboarders and the like, enjoy listening to music while engaging in vigorous physical activities which may include the risk on inevitability of getting wet. One method for the participant to listen to his/her favorite music while engaged in the vigorous physical activity is to listen to a compact disk. However, a CD player has many inherent problems such as the weight, track skipping, and size. Additionally, for snowboarding and swimming, participants may not be able to listen to music with CD players because CD players are not water resistant. Moreover, CD players are typically too large and too heavy for the active person to carry while engaging in the vigorous physical activity.

Accordingly, there is a need in the art for an improved music playing device wherein a user may listen to music while participating in vigorous physical activity including water related sports. Moreover, there is a need in the art for an assembly process and a machine for assembling the improved music playing device. Additionally, there is a need in the art for a method and machine to test whether the music player will function (e.g., waterproof) while the participant engages in vigorous physical activity and/or water related activities.

### BRIEF SUMMARY

The present invention addresses the needs discussed above, those discussed below and those that are known in the art.

A waterproof test machine is described herein. The waterproof test machine may comprise a leak test chamber, a rigid tube in fluid communication with the leak test chamber and a vacuum pump. The vacuum pump may be activated via a computer to apply vacuum pressure within the leak press chamber to determine whether the music player is waterproof.

The waterproof test machine may subject the music player or electronic device to a waterproof test process. The test process subjects the music player to various vacuum pressures. The vacuum pressure in the leak test chamber is then measured over a period of time to determine a leak rate. If the leak rate is below an allowable leak rate, then the music player is determined to be waterproof at a rated water depth. If the leak rate is above the allowable leak rate, then the music player is failed, disassembled and salvaged.

The rated water depth corresponds to the test vacuum pressure. In particular, if the rated depth of the music player is 10 feet, then the test vacuum pressure is about 5.3 psig. The reason is that the music player will be subjected to about 5 psig at a water depth of 10 feet. A 0.3 psig safety factor is used. The leak rate of the music player is measured after the leak test chamber is subjected to the corresponding test vacuum pressure of the rated water depth. The music player is passed or failed based on the leak rate, as discussed above.

In an aspect of the steps to assemble the music player, one of the steps comprises the step of inserting a rigid member into a flexible member. During use of the music player, the user controls operation of the music player by pushing the flexible member which subsequently traverses the rigid member to operate switches connected to a printed circuit board. The flexible member creates a waterproof seal such that water does not enter the music player via a button aperture formed to receive the flexible member/button.

In another aspect of the steps to assemble the music player, one of the steps comprises placing an o-ring about a plug. The o ring is disposed in matching grooves of upper and lower housings. The o ring and the grooves form a waterproof seal such that water does not enter through the plug aperture of the housing.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an illustration of a swimmer listening to music with a water resistant and shock resistant music player wherein the music player is engaged to the participant's arm via an arm band;

FIG. 2 is a perspective view of the music player removed from the arm band and an earphone removed from an earphone plug of the music player;

FIG. 3 is an exploded perspective view of the music player illustrating four buttons and the earphone plug wherein rim portions of buttons and a ring disposable about the plug are respectively received into rim grooves and a ring groove to make the music player water resistant;

FIG. 4 is a top view of the upper housing with alignment pins of the upper housing engaged to alignment holes of the PCB board and the ring disposed about the plug received into the ring groove of the upper housing;

FIG. 5 is a cross sectional top view of the button in the button aperture illustrating a rim portion of a flexible member disposed within the rim groove for forming a water tight seal therebetween;

FIG. 6 is a cross sectional front elevational view of the button in the button aperture illustrating a band disposed in recesses of the upper and lower housing periphery;

FIG. 7 is a flow diagram for assembling the music player;

FIG. 8 is a flow diagram for a step of applying a conformal coating step shown in FIG. 7;

FIG. 9 is a flow diagram for a step of attaching a transparent window step shown in FIG. 7;

FIG. 10 is a perspective view of a conformal coating machine;

FIG. 11 is a perspective view of a sonic welding machine for sonically welding a transparent window to a housing of the music player;

FIG. 12 illustrates the steps shown in FIG. 7 of inserting a rigid member into a flexible member, inserting the flexible members into apertures of a band, disposing an O-ring about a plug, assembling a PCB on the band, aligning a button of a switch to a second distal end of the rigid member, disposing a compressible material in an upper housing and disposing the PCB on the upper housing;

FIG. 13 illustrates the steps of placing the music player assembly into a fixture and traversing a horn downward recited in FIG. 7;

FIG. 14 illustrates a leak test chamber in an open position with a music player disposed therein; and

FIG. 15 illustrates the leak test chamber and a leak test control unit for testing whether the music player is waterproof.

### DETAILED DESCRIPTION

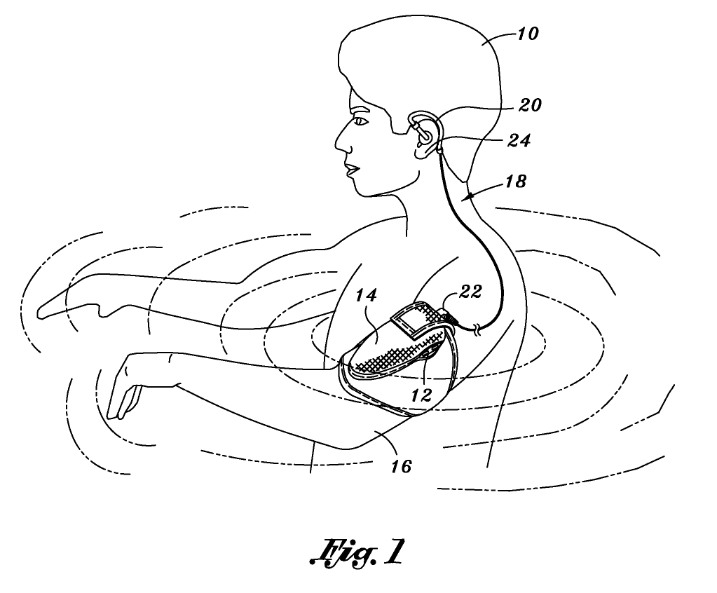

Referring now to the drawings which are for the purposes of illustrating the preferred embodiments of the present invention and not for the purposes of limiting the same, FIG. 1 illustrates a user 10 listening to a music player 12 while swimming. The music player 12 is inserted into an armband 14 wrapped and secured to a left arm 16 of the person 10. An ear phone 18 is also shown having an ear bud 20 and a jack 22. The jack 22 is connected to the music player 12 and the ear bud 20 is inserted into an ear 24 of the user 10. The music player 12 permits the user 10 to simultaneously swim and listen to music.

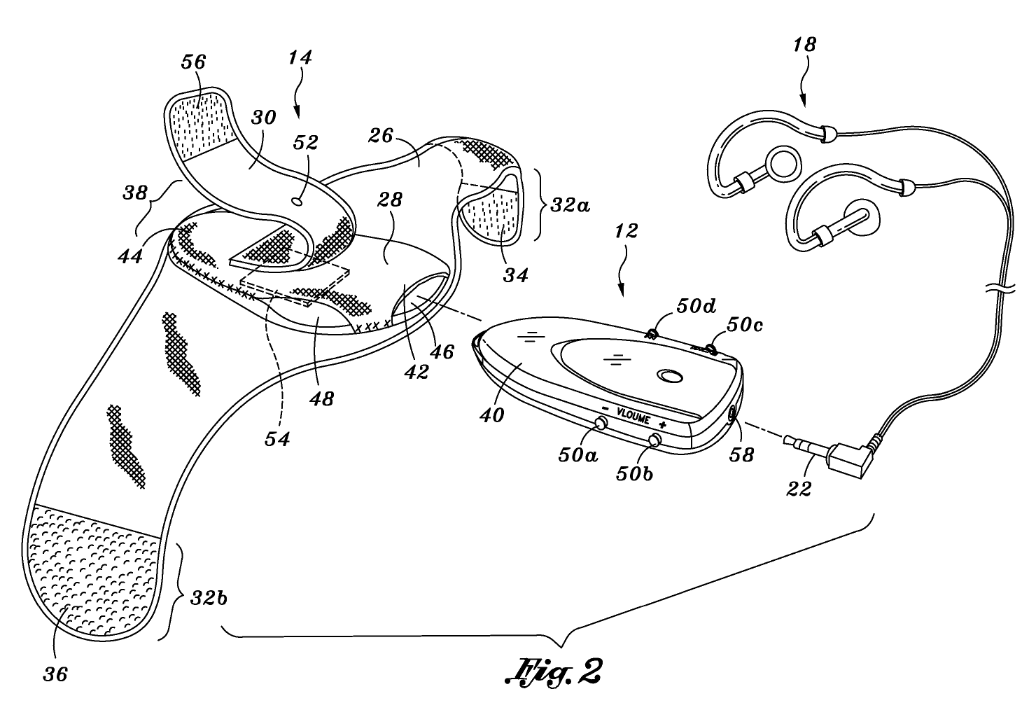

FIG. 2 illustrates the armband 14, the music player 12 and the earphone 18. The armband 14 may comprise a strap 26, pouch 28 and a closing flap 30. The strap 26 may be fabricated from a neoprene material and sized and configured to fit around the user's arm 16. The distal ends 32a, b of the strap 26 may have hooks 34 and loops 36 respectively attached to ends 32a, b. The strap 26 may be wrapped around the user's arm 16, and the hooks 34 and loops 36 may engage each other to attach the armband 14 to the user's arm 16.

The pouch 28 may be attached to a central portion 38 of the strap 26 on its outside surface. The pouch 28 may also be fabricated from a neoprene material sized and configured to the general shape of a casing 40 of the music player 12. In particular, the pouch 28 may be fabricated to have a rounded top portion 42 and tapered bottom portion 44. The pouch 28 may further define an entrance/exit or opening 46 through which the music player 12 may be inserted into or removed from the pouch 28. The opening 46 may be smaller than the music player 12 such that the opening 46 must be stretched open to insert the music player 12 into the pouch 28 or to remove the music player 12 from the pouch 28. This provides additional capture of the music player 12 inside the pouch 28 in addition to the closing flap 30. The pouch 28 may further have button openings 48 on the left and right hand sides of the pouch 28 sized, configured and positioned to allow the user 10 to feel and depress buttons 50a-d of the music player 12. The closing flap 30 may be attached to an outside surface of the pouch 28 and removably attachable to an inside surface of the strap 26. The closing flap may a jack aperture 52 sized and configured to receive the jack 22 of the earphone 18, as shown in FIGS. 1 and 2. The inside surface of the strap 26 and the inside surface of the closing flap 30 may be respectively lined with hooks 54 and loops 56 such that the closing flap 30 may cover the opening 46 when the closing flap 30 is in a closed position (see FIG. 1) and the hooks 54 and loops 56 lined on the inside surfaces of the strap 26 and closing flap 30 may be engaged to each other. In the closed position, the jack aperture 52 may be aligned to a plug 58 of the music player 12 such that the jack 22 of the earphone 18 may be plugged into the plug 58 when the flap 30 is in the closed position. To remove the music player 12 from the pouch 28, the user 10 may remove the jack 22 from the plug 58. The loops 56 may be disengaged from the hooks 54, and the music player 12 may be slipped out of the pouch 28 through opening 46.

The discussion of the operation of the music player 12 itself is exemplary and not meant to limit the present invention. It is also contemplated that other operation schemes may be employed in conjunction with the various aspects of the music player 12 discussed herein. The music player 12 may be turned on by pressing the on/off button 50c for three seconds while the jack 22 of the earphone 18 (i.e., output devices) is attached to the plug 58. The music player 12 may be turned off by disengaging the jack 22 from the plug 58. Alternatively, and more preferably, the music player 12 may be turned off by depressing the on/off button 50c for three seconds. While the music player 12 is on, a subsequent song or previous song may be played by depressing either the next track button 50c or the previous track button 50d, respectively. To replay the current song, the previous track button 50d may be depressed. To adjust the volume, the increase or decrease volume buttons 50a, b may be depressed. These buttons 50a-d activate the switches 60a-d (see FIG. 3) formed on a PCB 62 to control the music player 12.

The music player 12 may be manufactured to be water resistant such that the user 10 may engage in water sports while listening to his or her favorite music. Additionally, the music player 12 may be shock resistant such that the user 10 may engage in vigorous physical activity without interruption of the music being played. To this end, as shown in FIG. 3, the music player 12 may have a plurality of electronic components 64 formed on the printed circuit board (PCB) 62. The PCB 62 and the electronic components 64 may cooperate with each other to play music. The electronic components 64 may include a battery which may be rechargeable and a flash memory (by way of example and not limitation, 128 megabyte, 256 megabyte and 1 gigabyte). The electronic components 64 may include software embedded on an IC chip to play music downloaded onto the flash memory. The software may play MP3 formatted music as well as all common music formats.

The plug 58 may also be attached to the PCB 62 at a distal end thereof. The plug 58 may be a 3.5 mm plug and may also be waterproof. The plug 58 may be connected to output devices such as amplified speakers, headphones, earphones 18, and the like. The plug 58 may also be connected to a USB cable adaptor. The USB cable adaptor may have a cable jack and USB connector with a cable connecting the cable jack and the USB connector. The cable jack may be inserted into the plug 58 and the USB connector may be connected to a USB port of a computer to permit downloading of music files from the computer to the music player 12, and more particularly, to the flash memory of the music player 12. Additionally, the USB cable adaptor may provide power to the music player 12 for recharging the battery of the music player 12.

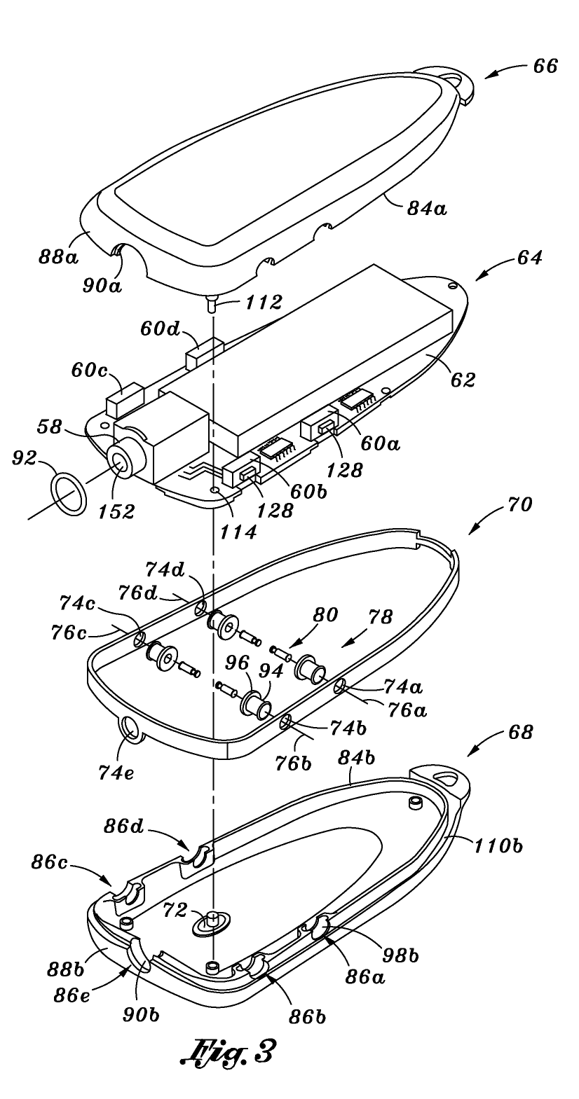

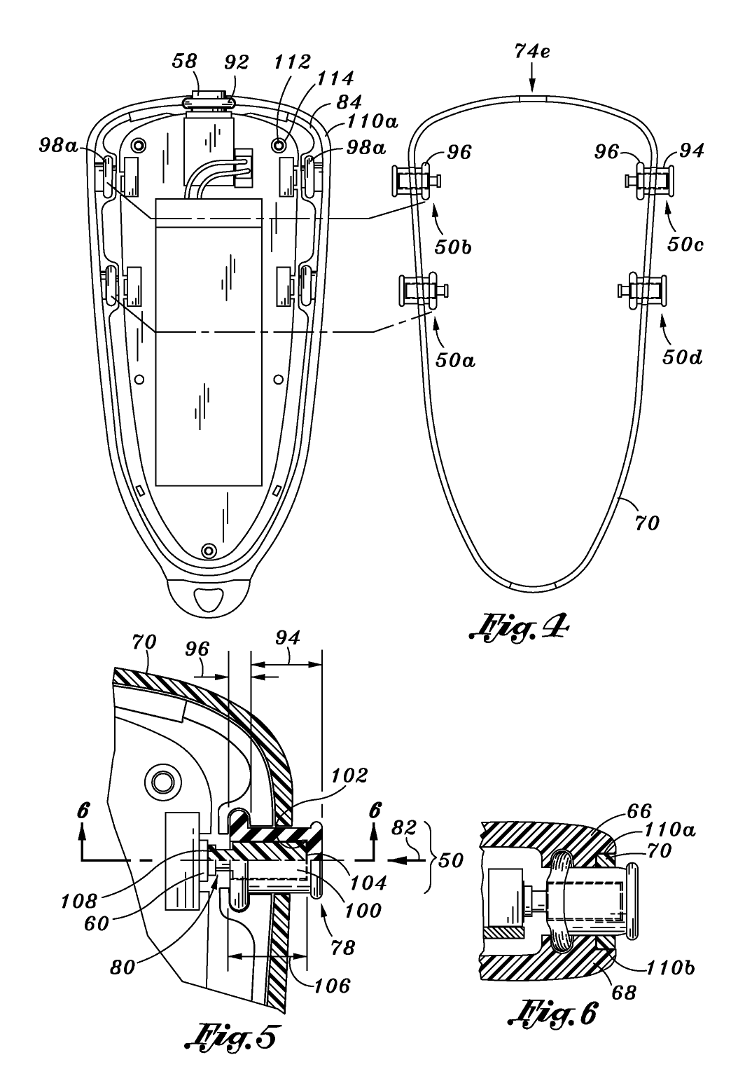

The music player 12 may have an upper housing 66, a lower housing 68 and a band 70 disposed therebetween which when assembled together forms a cavity to contain the electronic components 64 and resists water from entering into the cavity. The lower housing 68 may have a transparent window 72 such that a light emitting diode (LED) may emit light through the transparent window 72. The LED may be one of the electronic components 64 attached to the PCB 62. The LED functions to indicate a status of the MP3 player 12 such as whether a song is being played or whether the battery of the music player 12 is being charged. The band 70, upper housing 66 and lower housing 68 may contact each other to form a water tight seal therebetween. For example, the upper housing 66, lower housing 68 and the band 70 disposed therebetween may be sonically welded to each other. The band 70 may have a plurality of apertures 74a-d for receiving the buttons 50a-d (see FIG. 4) and the plug 58. In particular, an upper portion of the band 70 may have a plug aperture 74e sized and configured to receive the plug 58 therethrough. Left and right portions of the band 70 may have two button apertures 74a, b and 74c, d on each portion. The button apertures 74a-d may be sized and configured to receive buttons 50a-d, respectively. The buttons 50a-d may be operative to control switches 60a-d, respectively, attached to the PCB board 62. A center line 76a-d of the button apertures 74a-d, respectively, may be aligned to the switches 60a-d attached to the PCB board 62 when the MP3 player 12 is assembled. The buttons 50a-d may have flexible members 78 which permit minute movements of rigid members 80 through the apertures 74a-d. The rigid member 80 may be disposed through a core of the button 50a-d. As shown in FIG. 5, the rigid member 80 may be aligned to the switch 60 and in contact therewith and extend into the distal tip of the button 50. Depressing the flexible member 78 in the direction of arrow 82 by the user's fingers is operative to traverse the rigid member 80 against the switch 60 and depress the switch 60 to control the operation of the music player 12, as shown in FIG. 6.

The upper and lower housings 66, 68 may have a cup-shaped configuration. A periphery of each of the upper and lower housings 66, 68 may define an interface surface 84a, b (see FIGS. 3 and 4). The upper housing 66 may be disposed above the lower housing 68 with the interface surface 84a of the upper housing 66 in alignment with the interface surface 84b of the lower housing 68. When the interface surfaces 84a, b of the upper housing 66 and the lower housing 68 are in contact with each other, a cavity is formed therebetween which houses the electronic components 64. When the interface surfaces 84a, b of the upper and lower housings 66, 68 are sonically welded, a watertight seal is formed therebetween. However, the upper and lower housings 66, 68 form button apertures 86a-e for the buttons 50a-d and the plug 58. As such, water may still enter the cavity through button and plug apertures 86a-e but is prevented as discussed below.

The button and plug apertures 86a-e permit the user 10 of the music player 12 to insert a jack 22 of an earphone 18 into a plug 58 attached to the PCB board 62 and to depress buttons 50a-d to control the switches 60a-d. More particularly, the plug 58 may be attached to the PCB board 62 and extend through sidewall portions 88a, b (see FIG. 3) of the upper and lower housings 66, 68. The plug 58 may have a generally circular configuration. The plug aperture 86e may be sized to be slightly larger than a diameter of the plug 58 such that the plug 58 may be inserted therethrough. The plug aperture 86e may be defined by a semi-circularly shaped depression formed in the lower housing 68 which mates with a corresponding semi-circularly shaped depression in the upper housing 66. When the interface surface 84a of the upper housing 66 mates with the interface surface 84b of the lower housing, then plug aperture 68e is formed.

The semi-circularly shaped depressions may have donut shaped grooves 90a, b (see FIG. 3) sized and configured to receive a ring 92 disposable about the plug 58. During assembly, the PCB board 62 with the plug 58 attached thereto may have the ring 92 disposed about the plug 58. The PCB board 62 may be disposed within the upper housing 66 with the plug 58 disposed in the semi-circularly shaped depression of the upper housing 66. Moreover, the ring 92 disposed around the plug 58 may be disposed in groove 90a of the upper housing 66. The interface surface 84a of the upper housing 66 may be aligned and placed in contact with the interface surface 84b of the lower housing 68. Moreover, in this position, the depression formed in the sidewall portion of the lower housing 68 also receives the plug 58, and the groove 90b receives the ring 92 disposed around the plug 58. The interface surfaces 84a, b of the upper and lower housings 66, 68 may be sonically welded to each other to assemble the music player 12. When assembled, the ring 92 being slightly larger than the grooves 90a, b is snugly fitted within the grooves 90a, b of the lower and upper housings 66, 68. The snug fit between the ring 92 and the grooves 90a,b of the housings 66, 68 forms a watertight seal therebetween. In this manner, a jack 22 of the earphone 18 may be plugged into the plug 58 for receiving electronic signals from the music player 12 and delivering such signals to the ear bud 20 of the earphone 18 such that the user 10 may enjoy listening to the music being played while in wet conditions.

The buttons 50a-d which control the operations of the music player 12 may be inserted into button apertures 86a-d so as to form a water tight seal therewith. In particular, the buttons 50a-d may have the flexible member 78 and the rigid member 80, as shown in FIG. 3. The flexible member 78 may have a hat-shaped configuration defined by a nub portion 94 and a rim portion 96. The nub and rim portions 94, 96 may have cylindrical configurations (see FIG. 3) wherein a central axis of the nub portion 94 and a central axis 96 of the rim portion 96 are aligned with each other. The nub portion 94 and the rim portion 96 may be fabricated from a unitary material such as rubber or other elastomeric material. The button apertures 86a-d for receiving the buttons 50a-d may be defined by semi-circularly shaped depressions formed in the upper and lower housings 66, 68. The button apertures 86a-d may be sized and configured to receive the nub and rim portions 94, 96 of the flexible member 78 and the rigid member 80, as shown in FIG. 5. The semi-circularly shaped depressions formed in the upper and lower housings 66, 68 may also have donut shaped grooves 98a, b (see FIGS. 3 and 4). Groove 98a of the upper housing 66 is best shown in FIG. 4, and groove 98b of the lower housing 68 is best shown in FIG. 3. The donut shaped grooves 98a, b of the upper and lower housings 66, 68 may collectively receive the rim portion 96 of the flexible member 78. When the rim portion 96 is received in the grooves 98a, b of the upper and lower housings 66, 68 and the interface surfaces 84a, b of the upper and lower housings 66, 68 are assembled (e.g., sonic welding, etc.), a watertight seal is formed between the interface surfaces 84a, b of the upper and lower housings 66, 68 as well as between the button 50 and the button aperture 86.

The button apertures 86a-d (see FIG. 3) may also define a central axis which is in alignment with the switches 60a-d attached to the PCB board 62, as shown in FIG. 5. Additionally, a hole may be formed through the rim portion 96 and the nub portion 94 of the flexible member 78. The hole may extend through the rim portion 96 and extend to the nub portion 94. However, the hole should not extend through the entire nub portion 94 so as to make a hole through the button 50 such that water does not enter the housing through such hole.

The hole and rigid member 80 may be sized and configured such that the rigid member 80 may snuggly fit within the hole but may also be slidable therethrough. A first distal end 100 of the rigid member 80 may have a bulbous configuration with an edge 102 (see FIG. 5) to prevent the rigid member 80 from being pulled out of the hole. The first distal end 100 of the rigid member 80 may be inserted into the hole until the first distal end 100 contacts a bottom 104 of the hole. The rigid member 80 may be longer than a depth 106 of the hole and a second distal end 108 of the rigid member 80 may be disposed adjacent to a switch 60. When the upper and lower housings 66, 68 are assembled with the buttons 50a-d and PCB board 62, the user 10 may press the button 50 in direction 82 to slide the rigid member 80 through the hole such that the second distal end 108 of the rigid member 80 depresses the switch 60 (see FIG. 6). This controls the operation of the music player 12. When the user's finger releases the button 50, the switch 60 springs outwardly and traverses the rigid member 80 back to its normal position (see FIG. 5).

As shown in FIG. 6, the band 70 may be interposed between the upper and lower housings 66, 68. In particular, the upper and lower housings 66, 68 may be formed with a recess 110a, b about peripheries of the upper and lower housings 66, 68, as shown in FIGS. 3 and 4. More particularly, as shown in FIGS. 4 and 6, the upper housing 66 may be formed with a recess 110a about the periphery thereof. Also, as shown in FIGS. 3 and 6, the lower housing 68 may be formed with a recess 110b about the periphery thereof. The recesses 110a, b may be sized and configured to receive the band 70 therein such that the band 70 is substantially flush with an exterior of the upper and lower housings 66, 68, as shown in FIGS. 2 and 6. The band 70 may also have four button apertures 74a-d (see FIG. 3) which may be sized and configured to receive the nub portion 94 of the buttons 50a-d, as shown in FIG. 4. The band 70 with the buttons 50a-d inserted into the button apertures 74a-d may be placed into the recess 110a of the upper housing periphery with the rim portions 96 of the buttons 50a-d received into the grooves 98a. Additionally, the plug 58 with the ring 92 disposed thereabout may be inserted into aperture 74e. The interface surfaces 84a, b of the upper and lower housings 66, 68 may be aligned and sonically welded to each other, as shown in FIG. 6.

To assemble the music player 12, the ring 92 may be disposed about the plug 58. Alignment pins 112 (see FIG. 3) formed in the upper housing 66 may then be inserted into alignment holes 114 (see FIG. 3) formed in the PCB board 62, as shown in FIG. 4. At this time, the ring 92 is disposed in groove 90a of the upper housing 66. The rigid member 80 may be inserted into the holes of the flexible member 78 to assemble the button 50. The buttons 50a-d may be inserted into the button apertures 74a-d of the band 70, as shown in FIG. 4. Thereafter, the band 70 may be placed on the recess 110a of the upper housing periphery with the nub portions 94 of the buttons 50a-d placed into the semi-circularly shaped depressions of the upper housing 66 and the rim portions 96 placed into the grooves 98a. The interface surface 84b of the lower housing 68 may be aligned and engaged (e.g., sonically welded, etc.) to the interface surface 84a of the upper housing 66. The engagement of the interface surfaces 84a, b of the upper and lower housings 66, 68 creates a water tight seal therebetween. The ring 92 and the rim portions 96 of the buttons 50a-d create a water tight seal with the grooves 90a, b and 98a, b of the upper and lower housings 66, 68. Hence, water does not enter the cavity formed by the upper and lower housings 66, 68 thereby protecting the PCB board 62 from water damage.

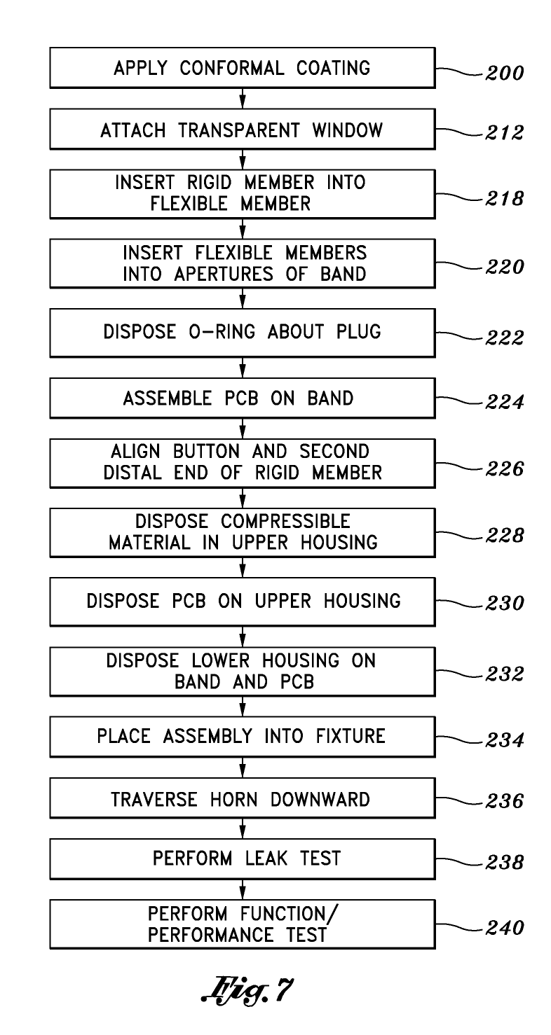

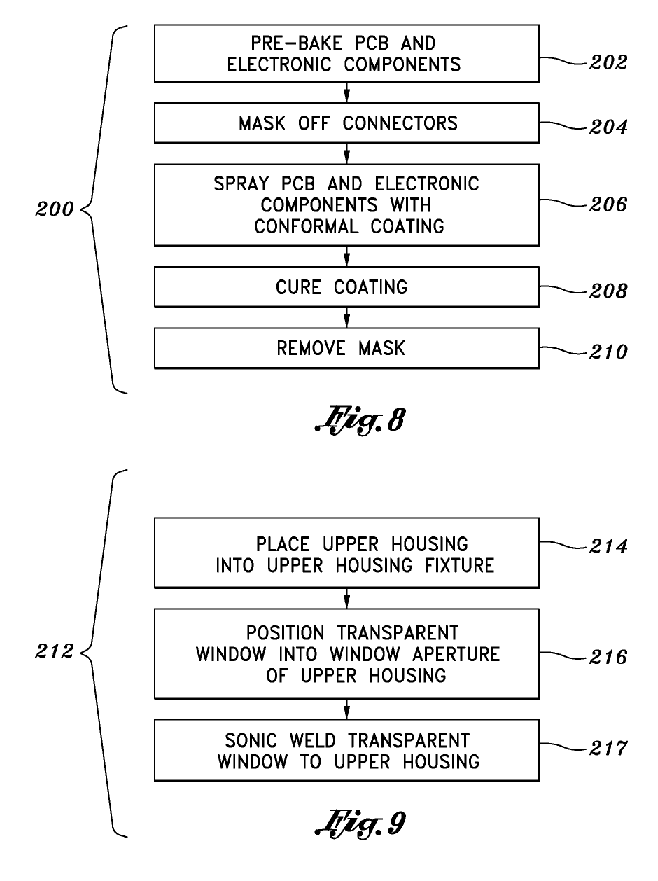

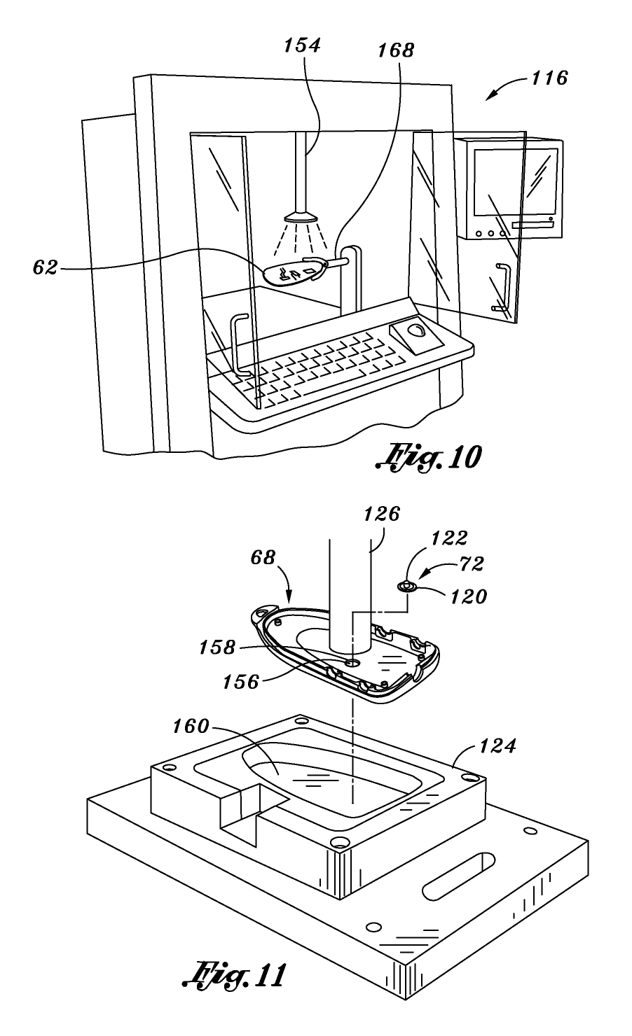

Referring now to FIGS. 7-15, the water and shock resistant music player 12 may be assembled in the following manner and assembled utilizing the machine shown in FIGS. 10, 11, and 13-15. As shown in FIG. 7, a first step 200 for assembling the music player 12 is to apply 200 a conformal coating to the printed circuit board 62 and/or the electronic components 64. The conformal coating assists the music player 12 to withstand all water forms such as water, ice, snow, humidity, condensation and the like that may cause an electrical short of the electronic system of the music player 12. By way of example and not limitation, the electronic components 64 may initially be attached to the printed circuit board 62 so as to electrically interconnect the electronic components 64 to each other. With the electronic components 64 attached to the printed circuit board 62, the electronic components 64 and the printed circuit board 62 may be prebaked 202 (see FIG. 8) for about four hours at a temperature of about 55 degrees Celsius or about 131 degrees Fahrenheit. After the prebake step 202 (see FIG. 8), the connectors (e.g., switches 60 and plug 58; see FIG. 3) may be masked off 204. For example, the exposed hole 152 (see FIG. 3) of the plug 68 as well as the moving mechanical parts (e.g., buttons 128; see FIG. 3) of the switches 60a-d may be masked off to prevent the conformal coating from covering the electrical contact in the plug 58 or operation of the switches 60a-d. Otherwise, the plug 58 and/or the switches 60 may become inoperative due to the conformal coating. After the masking off step 204, both sides of the printed circuit board 62 may be sprayed 206 with a conformal coating material such as humisel 1B31 type AR. After the spraying step 206, the conformal coating material may be air cured 208. After the curing step 208, the mask may be removed 210 from the connectors.

The step of applying 200 (see FIGS. 7 and 8) the conformal coating to the printed circuit board 62 and/or the electronic component 64 may be accomplished with a conformal coating machine 116 (see FIG. 10). The conformal coating machine 116 may be hand operated, manually operated, mechanically operated, computer operated, etc. The conformal coating machine 116 may have a spray gun 154 fluidically connected to container fitted with the conformal coating material. The spray gun 154 pumps the material through the spray gun and onto the printed circuited board 62 and the electronic components 64. A grip 168 of the conformal coating machine 116 manipulates (e.g., flips, turns, rotates, etc.) the PCB 62 with respect to the spray gun 154 so as to cover the entire PCB 62 with the conformal coating material.

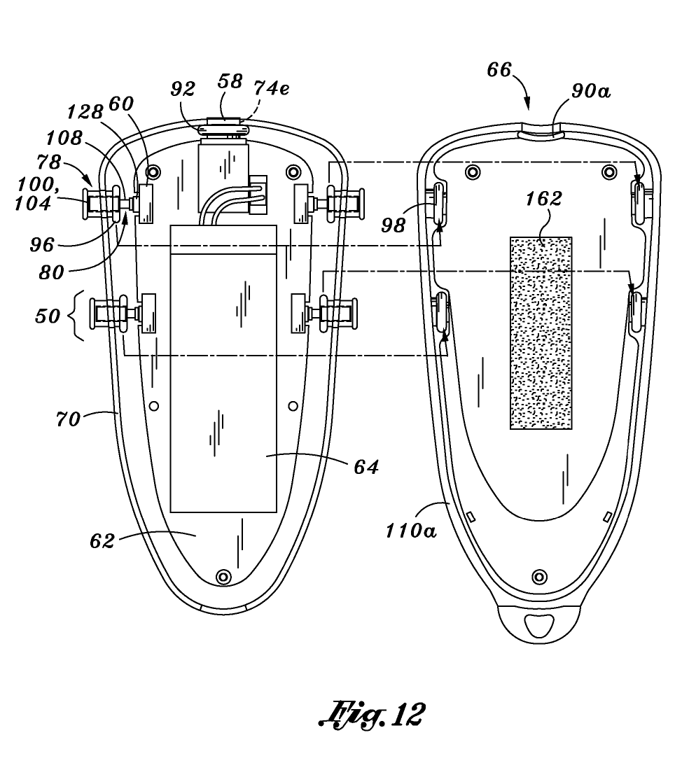

In a second step 212 (see FIGS. 7, 9 and 11), the transparent widow 72 (see FIG. 11) is formed 212 into the lower housing 68. In particular, the lower housing 68 may have a window aperture 156 at or about the upper portion thereof, as shown in FIGS. 2, 3 and 11. The transparent window 72 may be sized and configured to contact the entire periphery 158 of the window aperture 156 formed in the lower housing 68. The transparent window 72 may define a base portion 120 and a nub portion 122.

To attach 212 the transparent window 72 to the window aperture 156 of the lower housing 68, the lower housing 68 may be placed in a fixture 124 (see FIG. 11) sized and configured to receive the lower housing 68. The inner cavity 160 of the fixture 124 may have a substantially mirror configuration as the exterior surface of the lower housing 68 such that the lower housing 68 does not move or wiggle within the inner cavity 160 of the fixture 124. The lower housing 68 may be placed 214 (see FIG. 9) into the fixture 124 with the exterior surface of the lower housing 68 contacting the interior cavity 160 of the fixture 124. After placing 214 the lower housing 68 into the fixture 124, the transparent window 72 may be placed adjacent to the window aperture 156 of the lower housing 68. In particular, the base portion 120 of the transparent window 72 may contact the periphery 158 of the window aperture 156. The nub portion 122 may have a cylindrical configuration and be positioned so as to be oriented in an upward direction (see FIG. 11). After positioning 216 the transparent window 72 into the lower housing 68, a sonic weld horn 126 may be traversed downward and onto the transparent window 72. The sonic weld horn 126 may also have a recess for receiving the nub portion 122 of the transparent window 72. The transparent window 72 may now be sonically welded 217 to the lower housing 68 at the window aperture 156 of the lower housing 68. The sonic welding 217 (see FIG. 9) of the transparent window 72 to the lower housing 68 creates an airtight and watertight seal such that water and air cannot pass through the window aperture 156 of the lower housing 68.

As shown in FIG. 12, the rigid member 80 may be inserted 218 (see FIG. 7) into the flexible member 78. In particular, the first distal end 100 of the rigid member 80 may be inserted 218 into the hole of the flexible member 78 until the first distal end 100 contacts a bottom 104 of the flexible member hole (see FIG. 12).

After inserting 218 the rigid member 80 into the flexible member 78, the flexible member 78 may be inserted 220 (see FIG. 7) through the button aperture 74 of the band 70. Each button aperture 74a-d may have one flexible member 78 inserted therethrough 74. After inserting 220 the flexible member 78 into the button aperture 74, the O-ring 92 is disposed 222 (see FIG. 7) about the plug 58. After disposing 222 the o-ring 92 about the plug 58, the printed circuit board 62 is assembled 224 within the band 70, as shown in FIG. 12. In particular, the plug 58 is pushed through the plug aperture 74e of the band 70. The second distal end 108 of the rigid members 80 are aligned 226 (see FIG. 7) to the buttons 128 of the switches 60. Each of the buttons 50 may be depressed to assure proper functioning of the switches 60.

A compressible material 162 (see FIG. 12) may be disposed 228 (see FIG. 7) against the interior surface of the upper housing 66. The compressible material 162 may be sufficiently thick so as to press against the electronic components 64 and/or circuit board 62. During use, the compressible material 162 absorbs any shock to prevent damage to the electronic components 64 and the printed circuit board 62. Preferably, the compressible material 162 is a foam strip adhered onto the interior surface of the upper housing 66.

After disposing 228 the compressible material into the upper housing 66, the band 70 and the printed circuit board 62 are disposed 230 into the upper housing 66 (see FIG. 12). The electronic components 64 may compress the compressible material to prevent or absorb shock experienced by the music player 12. The band 70 and the printed circuit board 62 is disposed 230 into the upper housing 66 in the following manner. The band 70 contacts the recess 110a of the upper housing 66 (see FIGS. 6 and 12). The O-ring 92 is disposed within the groove 90a of the upper housing 66. Also, the rim portions 96 of the flexible member 78 of the buttons 50a-d are disposed within respective grooves 98a of the upper housing 66. At this point, the rigid members 80 should still be aligned to the buttons 128 of the switches 60. If not, then the rigid members 80 should be readjusted such that the rigid members 80 are aligned to the buttons 128 of the switches 60 such that depression of the buttons 50a-d actuates the switches 60.

After disposing 230 the printed circuit board and band 70 into the upper housing 66, the lower housing 68 may be disposed 232 on the band 70, printed circuit board 62 and the upper housing 66. In particular, the lower housing 68 is aligned to the band 70, printed circuit board 62 and the upper housing 66 when the rim portions 96 are disposed within the respective grooves 98b (see FIG. 3) of the lower housing 68. Additionally, the O-ring 92 is disposed within the groove 90b (see FIG. 3) of the lower housing 68. At this point, the band also contacts the recess 110b (see FIG. 3) of the lower housing 68.

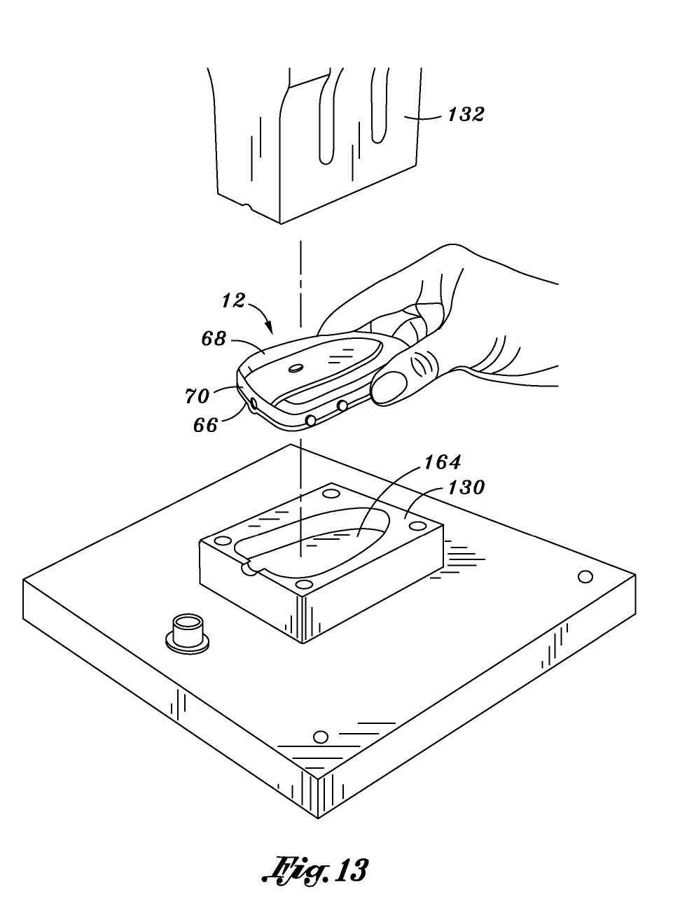

The assembled but loose upper housing 66, printed circuit board 62, band 70 and the lower housing 68 are placed 234 (see FIGS. 7 and 13) into a fixture 130 (see FIG. 13) sized and configured to receive the upper housing 66. By way of example and not limitation, the internal cavity 164 of the fixture 130 may have a reverse configuration as the exterior surface of the upper housing 66. The internal cavity 164 of the fixture 130 should be sized and configured to the exterior surface of the upper housing 66 such that the assembled but loose music player 12 does not unduly move or wiggle within the fixture 130. After placing 234 the assembled but loose music player 12 into the fixture 130 a horn 132 is traversed downward onto the lower housing 68. The upper housing 66, lower housing 68 and the band 70 are sonically welded to each other. The horn 132 may be custom made to fit the design of the music player 12 to provide precise welding of the parts to insure airtight, waterproof component manufacture. By way of example and not limitation, the horn 132 may provide pressure about the periphery of the lower housing 68 such that the interface surfaces 84a-b (se FIG. 3) are sonically welded to each other. Also, the band 70 may be sonically welded to interface surfaces 110a, b.

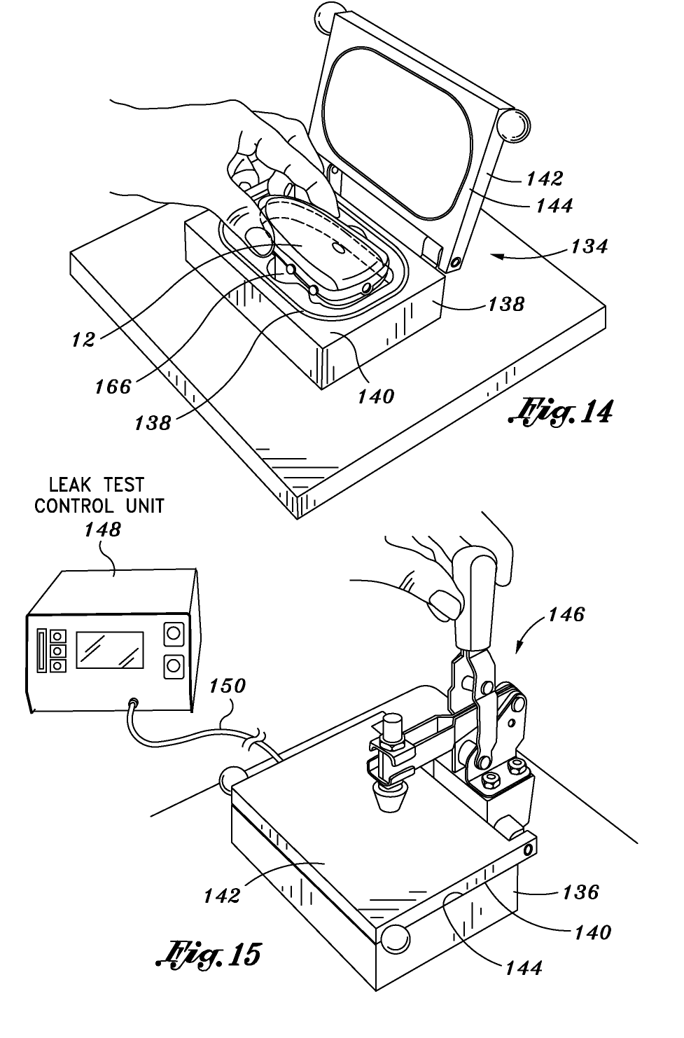

After sonically welding 234, 236 (see FIG. 7) the upper housing 66 to the lower housing 68, the assembled and attached music player 12 is leak tested 238 (see FIGS. 7, 14 and 15). In particular, the music player 12 may be placed within a leak test chamber 134 (see FIGS. 14 and 15). The leak test chamber 134 may comprise a base member 136 of the leak test chamber 134. The base member 136 may have an internal cavity 166 sized and configured to receive the music player 12. A gasket 138 may be formed about the periphery of the internal cavity 166 of the leak test chamber 134. The gasket 138 may protrude out of a top surface 140 of the base member 136. More particularly, the music player 12 may be disposed at a lower elevation compared to the gasket 138. A lid member 142 may be rotated and closed over the internal cavity 166 of the base member 136. A bottom surface 144 of the lid member 142 contacts the gasket 138. A clamp 146 (see FIG. 15) may be used to apply downward pressure on the lid member 142 such that there is an airtight seal between the top surface 140 of the base member 136 and the bottom surface 144 of the lid member 142 via the gasket 138.

The internal cavity 166 of the leak test chamber 134 may be in fluid communication with a vacuum pump. The vacuum pump is operative to create a vacuum within the internal cavity 166 of the leak test chamber 134. By way of example and not limitation, a through hole may be formed in the base member 136 of the leak test chamber 134. A rigid tube 150 may be fitted into the through hole and also connected to a leak test control unit 148. The leak test control unit 148 may contain the vacuum pump. The leak test unit 148 controls the vacuum pump to apply a vacuum pressure to the internal cavity 166 of the leak test chamber 134 as described below. Through such procedures, the music player 12 is waterproof tested without the application of water. The leak test unit 148 will indicate whether the music player 12 is waterproof or not based on a pass/fail signal. If the music player does not pass the leak test process or step 238 (see FIG. 7), then the music player 12 is disassembled and the boards are salvaged and retested.

For those music players 12 that pass the leak test 238, they 12 undergo a functionality and performance test 240 (see FIG. 7). The music player 12 is plugged into headphones or personal computer speakers and tested to insure that all switches, buttons and functions are working properly and that music is played back.

The sonic welder machine may be Dukane Sonic Welder.

Another advantage of the music player 12 is that the music player 12 is resistant to shocks. The user 10 may be engaged in vigorous physical activity such as surfing or cycling. The user 10 may be violently tumbled by the waves or may ride over bumps in the road. Nonetheless, the music player 12 continuously plays music without skipping. Moreover, the solid construction of the music player 12 prevents the shocks from destroying the music player 12.

As discussed above, the music player 12 is leak tested 238 by placing the music player 12 in an internal cavity 166 of the leak test chamber 134. The leak test chamber 134 is closed (see FIG. 15) and a vacuum pressure cycle is applied to the leak test chamber 134 via the leak test machine 148. The test sequence comprises two different tests which may be performed with a push of a start button on the leak test equipment 148. In particular, the first test sequence comprises the steps of applying the test vacuum pressure to the internal cavity 166 of the leak test chamber 134. Thereafter, the vacuum pressure in the internal cavity 166 is immediately sensed over a period of time (e.g., 3 seconds) via a vacuum pressure sensor of the leak test unit 148. A vacuum pressure drop in the leak test chamber 134 greater than an allowable vacuum pressure drop indicates a large leak in the music player 12 and the music player 12 is failed. If the music player 12 passes the first test sequence, then the music player 12 is subsequently subjected to a second test sequence which tests for smaller leaks. The second test sequence may comprise the steps of applying the test vacuum pressure to the internal cavity 166 of the leak test chamber 134. The vacuum pressure within the internal cavity 166 of the leak test chamber 134 is then allowed to stabilize. After the vacuum pressure has stabilized in the leak test chamber 134, the vacuum pressure is measured over a period of time. If the vacuum pressure drop (after stabilization) over the period of time in the leak test chamber 134 is greater than an allowable vacuum pressure drop, then the music player is failed and is not allowed to proceed to a next step of testing 240 the function and performance of the music player 12.

During the first and second test sequences discussed above, the leak test unit 148 may be calibrated to display a cubic centimeters per minute (i.e., ccm) leak rate based on the loss of vacuum pressure over a period of time. During the first and second test sequences discussed above, the leak rate is calculated based on the loss of vacuum pressure over a period of time. If the leak rate is greater than the allowable leak rate, then the music player 12 is failed and not allowed to pass to the next step. The allowable leak rate may be the same or different for the first or second test sequences. For example, during the first test sequence, the leak test chamber 134 is brought to the test vacuum pressure. Immediately thereafter, the vacuum pressure is sensed over a period of time. Based on the loss of pressure over the period of time, the leak rate is calculated. If the leak rate is greater than the allowable leak rate, then the music player 12 is failed and not allowed to pass to the next step. During the second test sequence, the leak test chamber is brought to the test vacuum pressure. The vacuum pressure is allowed to stabilize. After the vacuum pressure has stabilized, the vacuum pressure is sensed over a period of time. Based on the loss of pressure over the period of time, the leak rate is calculated. If the leak rate is greater than the allowable leak rate, then the music player 12 is failed and not allowed to pass to the next step.

The vacuum pressure has stabilized when the vacuum loss over a period of time is approximately linear. Initially, when the leak test chamber 134 is brought to the test vacuum pressure, the rate of pressure loss in the leak test chamber 134 may be greater than a linear rate. After a period of time, the leak rate or rate of vacuum pressure loss will approach a constant value. The leak rate during the linear portion of the cycle is compared to the allowable leak rate to determine whether the music player 12 is waterproof.

The leak test chamber 134 is brought to the test vacuum pressure during the first and second test sequences. The test vacuum pressure is derived from the rated water depth of the music player 12. The rated water depth is the depth that the music player 12 may be submerged in water and able to withstand entry of water into the music player 12 during its intended use. By way of example and not limitation, if the music player's rated water depth is ten feet, then the pressure applied to the music player 12 at a water depth of 10 feet is approximately less than 5 psig. A 0.3 psig is used as a safety factor. As such, the leak test chamber is brought to a vacuum test pressure of about 5.3 psig. Preferably the vacuum test pressure is a vacuum rather than a positive air or water pressure. However, a positive pressure may also be used during the first and second test sequences discussed above. If the rate of vacuum pressure loss corresponds to a leak rate less than about 5 cubic centimeters per minute (ccm), then the music player 12 is waterproof at the rated depth of 10 feet. Preferably, the leak rate should be less than about 0.5 sccm.

After the music player 12 is leak tested 238 via the leak test unit 148, the dry music player 12 is weighed to determine the weight of the music player 12. Thereafter, the music player 12 is submerged in water to the rated water depth (e.g., 10 feet) for approximately 48 hours. At the end of 48 hours, the music player 12 is removed from the water, dried and reweighed. If the weight of the music player 12 is the same before and after submersion of the music player 12 into the water, then the music player 12 is determined to be waterproof. This subsequent water submersion test may be performed on a small portion of music players 12 to sample the lot or on all of the music players 12.

The leak test unit 148 is programmable to operate the vacuum pump and sense the vacuum pressure within the leak test chamber 134 as discussed above such that with a push of a start button on the leak test unit 148, the music player 12 may be subjected to the first test sequence and the second test sequence if the music player passes the first test sequence.

In an aspect of the method and machinery, the leak test equipment may be a Uson Testra 1100.

The above description is given by way of example, and not limitation. Given the above disclosure, one skilled in the art could devise variations that are within the scope and spirit of the invention disclosed herein, including various ways of engaging the interface surfaces 84a, b of the upper and lower housings 66, 68. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of waterproof testing an electronic device at a rated water depth, the method comprising the steps of:
assembling the electronic device;
subjecting the electronic device to a test vacuum pressure associated with the rated water depth;
measuring a leak rate after the electronic device is subjected to the test vacuum pressure;
rejecting the electronic device if the leak rate is above an allowable leak rate; and
accepting the electronic device if the leak rate is below the allowable leak rate.

2. The method of claim 1 wherein the test vacuum pressure is greater than a calculated pressure at the rated water depth.

3. The method of claim 1 wherein the test vacuum pressure is equal to about 5.3 psig for a ten feet rated water depth.

4. The method of claim 3 wherein the allowable leak rate is less than 5 ccm.

5. The method of claim 4 wherein the allowable leak rate is less than 0.5 sccm.

6. The method of claim 1 wherein the assembling the electronic device step comprises the steps of:
inserting a rigid member into a flexible member; and
disposing the rigid and flexible members through a housing of the electronic device.

7. The method of claim 6 wherein a rim portion of the flexible member is disposed within grooves of the electronic device housing.

8. The method of claim 6 wherein the rigid member is inserted into a hole of the flexible member until a distal end of the rigid member contacts a bottom of the flexible member hole.

9. The method of claim 1 wherein the subjecting step comprises the steps of:
placing the electronic device within a leak test chamber; and
applying a vacuum pressure to the leak test chamber until the vacuum pressure within the leak test chamber is about equal to a test vacuum pressure.

10. The method of claim 1 wherein the assembling the electronic device step comprises the steps of:
disposing an O ring about a plug of the electronic device; and
disposing the O ring within a groove of an electronic device housing.

11. The method of claim 1 wherein the measuring the leak rate step is performed immediately after the electronic device is subjected to the test vacuum pressure.

12. The method of claim 11 further comprising the steps of:
subjecting the electronic device to the test vacuum pressure;
measuring the leak rate after the vacuum pressure has stabilized.

13. The method of claim 12 wherein the vacuum pressure has stabilized when a rate of vacuum pressure loss is linear.

14. The method of claim 1 wherein the measuring the leak rate is performed after the vacuum pressure has stabilized.

15. The method of claim 1 wherein the electronic device is a cell phone, mp3 player, electronic device with an audio output, video output, audio/video output, audio input, video input, and/or audio/video input, or combinations thereof.

16. The method of claim 1 wherein the assembling step comprises the step of applying a conformal coating to electronic components of the electronic device to protect the electronic components against rust or short circuit due to failure of a waterproof seal of the electronic device, humidity in a housing of the electronic device or condensation in the housing of the electronic device.

17. A method of waterproof testing an electronic device at a rated water depth, the method comprising the steps of:
assembling the electronic device;
subjecting the electronic device to a test vacuum pressure associated with the rated water depth;
measuring a rate of vacuum pressure loss after the electronic device is subjected to the test vacuum pressure;
rejecting the electronic device if the rate of vacuum pressure loss is above an allowable rate of vacuum pressure loss; and
accepting the electronic device if the rate of vacuum pressure loss is below the allowable rate of vacuum pressure loss.

18. The method of claim 17 wherein the measuring the rate of vacuum pressure loss step is performed immediately after the electronic device is subjected to the test vacuum pressure.

19. The method of claim 17 wherein the measuring the leak rate step is performed after the vacuum pressure has stabilized.

20. The method of claim 18 further comprising the steps of:
subjecting the electronic device to the test vacuum pressure;
measuring the rate of vacuum pressure loss after the vacuum pressure has stabilized.

21. The method of claim 20 wherein the vacuum pressure has stabilized when the rate of vacuum pressure loss is linear.

22. The method of claim 17 wherein the electronic device is a cell phone, mp3 player, electronic device with an audio output, video output, audio/video output, audio input, video input, and/or audio/video input, or combinations thereof.

23. The method of claim 17 wherein the assembling step comprises the step of applying a conformal coating to electronic components of the electronic device to protect the electronic components against rust or short circuit due to failure of a waterproof seal of the electronic device, humidity in a housing of the electronic device or condensation in the housing of the electronic device.
